(19) United States
(12) Patent Application Publication
(10) Pub. No.: US 2012/0011077 A1
(43) Pub. Date: Jan. 12, 2012

(54) Cloud Computing Governance, Cyber Security, Risk, and Compliance Business Rules System and Method

(76) Inventor: Bhavesh C. Bhagat, Leesburg, VA (US)

(21) Appl. No.: 13/016,999

(22) Filed: Jan. 29, 2011

Related U.S. Application Data
(60) Provisional application No. 61/363,479, filed on Jul. 12, 2010.

(51) Int. Cl. G06Q 99/00; G06F 21/00

(52) U.S. Cl. 705/317; 726/1

(57) ABSTRACT

Cloud Computing Governance, Cyber Security, Risk, and Compliance Business Rules System and Method that enable real-time, on-demand, transparent and complete perspective across the risks, threats and opportunities through an enterprise across many operational domains. Cloud platform ensures 24×7 “On Demand” risk-based private and public strategic alignment with regulatory and compliance priorities towards organizational governance objectives. A user can put in place tasks and controls for risks, and use the platform's cloud collaboration and workflow engine to track continuous remediation and governance improvements. Relate enterprise security, risks to multiple business rules which can be controls driven or efficiency driven ensuring on-going management of efficiency and risk monitoring. Design, maintain and modify an industry specific repository of business rules and process objectives, and easily manage the assessment and monitoring of specific business process control effectiveness at design, operational level.

### CROSS REFERENCE TO RELATED APPLICATIONS

This application claims priority from U.S. Patent Application Ser. No. 61/363,479, entitled “Cloud Computing Governance, Risk, and Compliance Business Rules System and Method”, filed on 12 Jul. 2010. The benefit under 35 USC §119(e) of the United States provisional application is hereby claimed, and the aforementioned application is hereby incorporated herein by reference.

### FEDERALLY SPONSORED RESEARCH

Not Applicable

### SEQUENCE LISTING OR PROGRAM

Not Applicable

### TECHNICAL FIELD OF THE INVENTION

The present invention relates generally to the field of corporate governance, sustainability and infrastructure as well as information cyber security and regulatory compliance. More specifically, the present invention relates to the field of regulatory compliance and information cyber security assurance management.

### BACKGROUND OF THE INVENTION

Cloud computing (‘cloud’) is an evolving term that describes the development of many existing technologies and approaches to computing into something different. Cloud separates application and information resources from the underlying infrastructure, and the mechanisms used to deliver them.

Cloud computing consists of a combination of third party data centers, Internet access, and pay-as-you-go, plus “multi-tenant” architecture. With cloud computing the actual computing takes place in a third-party data center, not on an individual's computer or within a company's own IT facilities. As a result, the user does not have to install or maintain a local copy of the software, invest in IT infrastructure, or maintain data centers.

Users access cloud software application over the public Internet or private Intranet with a browser. This means that they can retrieve their data and applications securely anywhere they have Internet access without dedicated networks or proprietary communication lines. It also means they can access information from multiple devices, like laptop computers and smart-phones. This enables the on-demand, 24×7, efficient and continuous means of application delivery and usage.

Enterprise cloud customers do not purchase cloud applications, but subscribe to them, usually on a per-seat or a per-usage basis for a period of time.

In order to be a true cloud computing system a combination of third party data centers, Internet access, and pay-as-you-go must be combined with “multi-tenant” architecture. Cloud computing is a model for enabling convenient, on-demand, 24×7, efficient and continuous means of application delivery and usage via network access to a shared pool of configurable computing resources (e.g., networks, servers, storage, applications, and services) that can be rapidly deployed or recalled with minimal management effort or service provider interaction. Computing resources are pooled to serve multiple consumers using the multi-tenant model. Different physical and virtual resources dynamically assigned and reassigned according to demand by the consumers.

A good analogy for multi-tenancy is an office building complex. The office-building complex enables large numbers of different tenants to conduct their operations in the same building. The tenants are not involved in the brick and mortar construction of the office-building complex nor are they involved with the physical maintenance of the office-building complex. Instead, they simply lease the office space and customize it to meet their needs. The landlord is responsible for physical improvements and physical maintenance to the building, and each time a physical improvement is made to the office building complex all of the tenants benefit. If a tenant's requirements change or if a tenant becomes dissatisfied with the building services or the office building complex can no longer meet the tenant's needs, the tenant can terminate his lease, take their personal effects and belongings and move, or open up a second location for their business.

Just as an office-building complex allows many different occupants to run their businesses within a single building or complex of buildings, a multi-tenant cloud-computing platform allows many different users to run their computer applications on the same computing platform. The users' data and applications are separated logically within the hardware and software, thus only the actual user can view their data and cloud services that pertain to them. This creates a computer space that is equivalent to the walls and privacy created by the bricks and mortar in the physical office-building complex. In this respect, multi-tenant cloud architecture is analogous to an online bank—an online bank conducting business over the internet services a number of business and individuals and allows them to use their business or individual accounts at the same time while keeping their private banking information separate and confidential through the logical (not physical) separation of data. In this regard, cloud computing can be private or public akin to a company having its own dedicated building complex sharing infrastructure for its own different departments (the private clouds) or a traditional office complex with different companies sharing the complex (the public cloud).

More specifically, cloud describes the use of a collection of services, applications, information, and infrastructure comprised of pools of compute, network, information, and storage resources. These components can be rapidly orchestrated, provisioned, implemented and decommissioned, and scaled up or down; providing for an on-demand utility-like model of allocation and consumption.

With multi-tenant cloud computing, the software applications are provided as a service to multiple customers on a single, large infrastructure stack. The configurations of each user are stored as metadata that describes the base functionality of their application and corresponds to their data and customizations. This metadata is then interpreted by the platform's runtime engine. In a robust multi-tenant, metadata cloud architecture there is a clear separation of the compiled runtime engine (kernel) and the application data. As a result, the kernel can be upgraded without disrupting customer's applications or data, thus allowing for continuous improvement in performance, reliability, security and scale. In short, multi-tenant computing yields massive cost, speed, scale and innovation advantages that single-tenant computing simply cannot match.

This present advance in technology and Cloud Computing is analogous to the Industrial age when Electricity and Power were not treated as utilities but rather an asset on manufacturing locations. Each factory usually had their own power generation sub-unit. With advances in technology we now have evolve to power grids and Cloud Computing is analogous in this sense with the advances in bandwidth and computing power becoming readily available it demands new and innovative ways to conduct business efficiently and yet needs for this environment to be well governed and secured from external as well as internal threats.

Cloud computing is gaining popularity among businesses of all sizes. This model is beginning to replace the traditional on-premises model of delivering software applications because, by comparison, cloud computing delivers unprecedented levels of ease, productivity, and success. With cloud computing, organizations can simply use readily available applications and services to focus on getting their work done. They're no longer saddled with the burdens and high capital expenditure costs of managing data centers, hardware, and software. Just as power companies relieve homeowners from having to maintain personal power generators for electricity, cloud-based solutions enable companies to manage resources more efficiently and where applicable to relieve companies from having to maintain dedicated computer systems and staff to provide their business applications.

Cloud computing has already been successfully implemented in organizations of all sizes around the world. It is estimated that the cloud computing market in 2009 was worth approximately $50 billion and it is projected to triple in value to $150 billion by 2013. Predictions for cloud computing growth estimate that 25% of new software deployments will be based on software-as-a-service cloud computing applications. Cloud computing is expected to see growth not only in consumer and business applications, but in government applications as well.

The power, simplicity and scalability of Cloud Computing have been proven and will see rapid adoption over next decade. However implementing right security strategies and design practices in Cloud rollouts is crucial upfront. Whether implementing private, public or hybrid clouds, the shift presents new challenges across the spectrum of GRC requirements and need to ensure that adopters of Cloud applications have better governance, risk management and security strategy and implementations from the get-go.

### SUMMARY OF THE INVENTION

Cloud Computing Based Corporate Governance, Risk, and Compliance Business Rules Management System and Method establishing transparent and comprehensive perspective across the governance factors, risks, threats and opportunities through an enterprise across many operational domains (including but not limited to) such as: Environmental Governance and Compliance; Corporate Ethics and Compliance; Corporate Sustainability initiatives; Information Technology Governance including Cloud Computing platform governance; Legal and Regulatory Compliance; Fraud Prevention and Detection; Financial Regulatory Compliance Operational Performance Documentation and Compliance; cyber security governance; Federal FISMA; Federal and State level certifications and accreditations situations; Occupational Health and Safety related governance; Contractual compliance; and Policy Management and Policy enforcement compliance.

The present invention enables fully clear and complete corporate governance and enterprise risk visibility ensuring proactive “On Demand” 24/7 risk-based private and public priorities towards organizational objectives. In many organizations practical tasks and processes of Governance Risk and Compliance (GRC) efforts are scattered across the enterprise. These disparate activities are then managed through siloed and rudimentary spreadsheets and manual processes across separate departments or through complex and costly GRC Legacy Automation in client server computing environments such as ERPs or other customized applications running in-house on client-server platforms. The present invention is geared toward eliminating the duplicity of efforts and streamlining governance initiatives and infusing efficiency inherent in the Cloud Computing platform into this process.

Private and Public organizations often struggle to align corporate strategic objectives and effective governance of hurdles in way of growth and the established corporate objectives. They increasingly feel the challenge in correlating board level vision with field level risk assessment and monitoring trends to gain an accurate picture of risk across the enterprise. The present invention's solutions are the next paradigm of secure, sustainable, and scalable yet extremely cost efficient governance, risk and compliance management dynamic business rules engine, built on a Cloud Computing System, to provide market-leading support for managing, monitoring, and reporting on opportunities and risks coming in way of overall corporate strategic goals. Delivered on a secure, flexible, scalable leading platform, the present invention's applications provide a powerful but easy to use enterprise solution that delivers significant advantages and cost benefits over traditional legacy Application Service provider (ASP) or client-server based GRC systems for organizations small and large across private and public enterprises. The present invention is designed to be deployed on a public (traditional) cloud, private (similar to VPN networking concepts) cloud, or a combination thereof referred to as a hybrid cloud.

CONFIDENT GOVERNANCE leverages latest cutting edge industry best practices and delivers them on CLEARGRC platform for effectively enabling adoption of cloud computing in most well governed manner. Whether implementing private, public or hybrid clouds, the shift presents new challenges across the spectrum of GRC requirements. Cloud Security Alliance's latest GRC stack and Cloud Control Audit Matrices are embedded in the Cloud Governance software for easy roll-out and adoption.

Achieving (GRC) goals requires appropriate assessment criteria, relevant control objectives and collaboration across all business users with real-time access to supporting data. With over two dozen industry vertical driven governance business solutions CLEARGRC provides the most impactful tool for enterprises, boards, financial and governance auditors, security solution providers, IT auditors and other key stakeholders to instrument and assess against industry established best practices, ethical and environmental standards and critical compliance requirements.

Business rules engine is at the heart of Cloud Governance. With key attributes, including source, business unit, risk owner and related process or business objective the rules enable focused risk based quantitative view of likelihood, impact and velocity of risk hurdles and a qualitative assessment of cost for both pre- and post-mitigated exposures. Ability to mesh this perspective with multitudes of reporting and management hierarchies across global operational regions, global regulatory and compliance mandates and policy enforcement creates a most powerful strategic risk and opportunity perspective for ALL levels of management seamlessly from highest Board level executive to machine operator or field level clerk in the organization.

Under the present invention a user can leverage these powerful cloud computing based business rules to automate the collection of risk based or operationally driven assessment metrics, including managing, tracking, testing, operational and audit driven compliance activities and gathering risk relevant dynamic and real-time information.

Under the present invention a user can share in real time their governance observations with their internal and external partners as they desire for collaborating seamlessly through internet for real-time risk based intelligence in security, internal controls and any other domain of their desire that assists them in managing and governing effectively to meet with regulatory compliance and other mandates. Put in place tasks and controls for risks, and use the platform's powerful workflow engine to assign and track the progress of risk oriented remediation and evidence gathering. Relate risks to multiple business rules and controls that ensure on-going management of risk in alignment with industry standard best practices such as ITIL, COBIT, COSO, ISO, NIST and Cloud Security Alliance (CSA) standards. Maintain a repository of global and local business rules and control objectives, and easily manage the assessment of corporate governance control effectiveness.

The present invention platform comes with powerful, highly customizable reporting dashboards with capabilities to report key risk management activities, provide regular updates to managers, and track and monitor global governance. This is uniquely geared towards the Risk based orientation of Board members and Audit committees as well as Field level managers today both in public and private sectors. The uniqueness of this usage of dashboard is in its simplicity for the highest level executives, such as board members and risk and audit committees in organizations who are often not close to day to day operations in the field to oversee strategic hurdles in corporate governance and growth objectives.

Therefore it is an objective of the present invention to provide improved corporate governance transparency and visibility across regulatory and compliance risk domain as well as operational and efficiency visibility across internal business process continuous refinement; thereby significantly improving the management of overall enterprise risk across the full operational domain of any enterprise, including but not limited to financial risks, regulatory risks, cyber security risks, political risks, fraud and corruption risk, legal ethics risks, privacy and data security risks, information technology risks, and compliance risks, and alignment with board level strategic priorities and goals, including tracking its mitigation using actions and business rules driven controls; benefit from a “On Demand” 24/7 centralized view of real-time risk across the entire organization; and make informed decisions with an interactive, intuitive and integrated web-based risk solution requiring nothing more than internet access and a personal computing device to access the internet in the form of present and future devices that enable as such.

It is another objective of the present invention to greatly reduce the costs of deploying and implementing a corporate governance and risk management solution through the cloud based on-demand per user, per month licensing model and by improving the efficiency of GRC lifecycle processes.

It is yet another objective of the present invention to provide a system that is customizable in days not months and years. Due to its cloud computing platform infrastructure and development architecture, the present invention can be implemented in days and scaled at a user's own pace to “grow” with the end user organization's experience to customize the solution to their specific risk and business requirements: including: custom fields, workflows, approval processes, reporting, and user interface customization. All this can be achieved without buying a single extra piece of hardware or software and just by subscribing to the cloud governance platform.

It is another objective of the present invention to teach a system that can rapidly deploy hundreds or thousands of users globally in fast and simple web-based deployment of the solution on multiple devices across multiple languages, geographic regions and platforms of hardware (such as mobile, laptop, desktops, etc.) with easy customization of user profiles, and no requirement for re-installation of new versions of the solution. Future technical upgrades are seamless and unhampering to work of the common business end-users.

It is yet another objective of the present invention to teach a system that provides business rules pre-customized by industry verticals that allows a user to leverage thousands of pre delivered rules libraries for their specific industry vertical, regulatory requirements and compliance domain and; subscribe to continuous business rules updates for confident real-time and up-to-date regulations and compliance; rapidly integrate with external data sources; and transform isolated, manual processes, spreadsheets and point solutions from virtually any legacy data source, thus achieving full and comprehensive real-time integration and fast import of existing data.

The power, simplicity and scalability of Cloud Computing have been proven and will see rapid adoption over next decade. However implementing right security strategies and design practices in Cloud roll outs is crucial upfront. CONFIDENT GOVERNANCE is an OEM and Implementation partner with leaders in Cloud Computing such as SALESFORCE.COM and MICROSOFT to ensure that customers adopting Cloud applications have better security strategy and implementation from the get-go.

### Definitions

Cloud computing. Software as a service (SaaS), and on-demand software are related terms that generally refer to hardware, software applications, and services that are available for immediate use because they execute in the cloud (the Internet). Cloud computing may also be thought of as utility-based computing because, similar to power and water utilities, users pay only for the resources they use on a month-to-month basis. Cloud computing consists of a combination of three features, Third-party data centers, Internet Access, and Pay-as-you-go used in combination with a “multi-tenant” architecture. Unless Third-party data centers, Internet Access, and Pay-as-you-go services are combined with a multi-tenant architecture, they do not constitute true cloud computing.

GRC. GRC is the industry standard acronym for “governance risk compliance”. It is the combined discipline to manage the activities occurring heretofore in separate domains of Corporate Governance, Risk Management and Regulatory and Operational Compliance.

IaaS, Infrastructure as a Service. This is a hardware layer. The actual hardware is usually (but not always) hidden from the user. This layer has hardware with memory, disk space, and one or more CPUs. From this layer, a user may install a variety of operating systems or launch pre-packed machine images that include a web server, database and other applications. In a public cloud scenario all users share IaaS. In a private public cloud scenario IaaS is only specific to one user but shared amongst departments. In a hybrid scenario public cloud scenario IaaS has some combination of both public and private clouds.

Internet Access. Users access cloud software over the public Internet with a browser or private intranet IF on a private cloud. This means that they can retrieve their data and applications anywhere they have Internet access without dedicated networks or proprietary communication lines. It also means they can access information from multiple devices, like laptop computers and smart-phones.

Multi-tenancy. NIST alludes to the essential requirement of multi-tenancy in its definition of cloud computing, which reads as follows:
“Cloud computing is a model for enabling convenient, on-demand network access to a shared pool of configurable computing resources (e.g., networks, servers, storage, applications, and services) that can be rapidly provisioned and released with minimal management effort or service provider interaction.”
   The definitive reference to multi-tenancy comes when NIST defines resource pooling: as “The provider's computing resources are pooled to serve multiple consumers using a multi-tenant model, with different physical and virtual resources dynamically assigned and reassigned according to consumer demand.”

PaaS, Platform as a Service. This is an application development and delivery environment. The application development tools provided allows a user to build web-based solutions and deploy them from within the system. A user does not have to know what the underlying hardware is, nor can I load up my own operating system but must only possess the know how to program within the environment. The advantage here is a user can leverage modules and tools that the vendor and others have developed.

Pay-as-you-go. Enterprise cloud customers do not purchase cloud applications, but subscribe to them, usually on a per-seat or a per-usage basis for a period of time.

SaaS, Software as a Service. To use the application a user does not need to know about the underlying hardware or development environment. Of course, they do need to understand the business processes and apply those processes to the SaaS application by configuring application security within the SaaS application. This is no different then any application implementation. The benefit is the software is already configured and ready to go. Plus, a user only pays for the resources they use or need.

Third-party data centers. With cloud computing the actual computing takes place in a third-party data center, not on an individual's computer or within a company's own IT facilities. As a result, the user does not have to install or maintain a local copy of the software, invest in IT infrastructure, or maintain data centers.

User. Generally refers to an individual person, group of individuals, organization, or other entity (including a computer or computer system), that employs the system and method taught by the present invention via a telecommunication system, or by a computerized information processing system. A person or computer that accesses a cloud system over a network. A user may be authenticated but can also be anonymous. A user does not have administrative privileges on a cloud system.

Cloud services exhibit five essential characteristics that demonstrate their relation to, and differences from, traditional computing approaches:

On-demand self-service. A consumer can unilaterally provision computing capabilities such as server time and network storage as needed automatically, without requiring human interaction with a service provider.

Broad network access. Capabilities are available over the network and accessed through standard mechanisms that promote use by heterogeneous thin or thick client platforms (e.g., mobile phones, laptops, and PDAs) as well as other traditional or cloud based software services.

Resource pooling. The provider's computing resources are pooled to serve multiple consumers using a multi-tenant model, with different physical and virtual resources dynamically assigned and reassigned according to consumer demand. There is a degree of location independence in that the customer generally has no control or knowledge over the exact location of the provided resources, but may be able to specify location at a higher level of abstraction (e.g., country, state, or datacenter). Examples of resources include storage, processing, memory, network bandwidth, and virtual machines. Even private clouds tend to pool resources between different parts of the same organization.

Rapid elasticity. Capabilities can be rapidly and elastically provisioned—in some cases automatically—to quickly scale out; and rapidly released to quickly scale in. To the consumer, the capabilities available for provisioning often appear to be unlimited and can be purchased in any quantity at any time.

Measured service. Cloud systems automatically control and optimize resource usage by leveraging a metering capability at some level of abstraction appropriate to the type of service (e.g., storage, processing, bandwidth, or active user accounts). Resource usage can be monitored, controlled, and reported—providing transparency for both the provider and consumer of the service.

It is important to recognize that cloud services are often but not always utilized in conjunction with, and enabled by, virtualization technologies. There is no requirement, however, that ties the abstraction of resources to virtualization technologies and in many offerings virtualization by hypervisor or operating system container is not utilized.

Public Cloud. The cloud infrastructure is made available to the general public or a large industry group and is owned by an organization selling cloud services.

Private Cloud. The cloud infrastructure is operated solely for a single organization. It may be managed by the organization or a third party, and may exist on-premises or off premises.

Community Cloud. The cloud infrastructure is shared by several organizations and supports a specific community that has shared concerns (e.g., mission, security requirements, policy, or compliance considerations). It may be managed by the organizations or a third party and may exist on-premises or off-premises.

Hybrid Cloud. The cloud infrastructure is a composition of two or more clouds (private, community, or public) that remain unique entities but are bound together by standardized or proprietary technology that enables data and application portability (e.g., cloud bursting for load-balancing between clouds).

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

FIG. 1 is a flow chart illustrating the positioning of the governance cloud;

FIG. 1a is a flow chart illustrating the infrastructure governance;

FIG. 1b is a flow chart illustrating the platform governance;

FIG. 1c is a flow chart illustrating the cloud management software integration;

FIG. 1d is a flow chart illustrating the cloud business application governance;

FIG. 2 is a flow chart illustrating the cloud governance application and rules for the infrastructure and platform;

FIGS. 3-3a is a flow chart illustrating the cloud governance use case;

FIG. 4 is a flow chart illustrating the dashboard methodology of the present invention;

FIG. 5 is a flow chart illustrating the reporting methodology of the present invention;

FIG. 6 is a flow chart illustrating the technical perspective governance object of the present invention;

FIG. 7 is a flow chart illustrating the technical perspective resilient risk object of the present invention;

FIG. 8 is a flow chart illustrating the technical perspective rules engine object of the present invention;

FIG. 9 is a flow chart illustrating the case management method of the present invention;

FIG. 10 is a flow chart illustrating the contract management method of the present invention;

FIG. 11a is an illustration of the GRC Extensibility API in PaaS;

FIG. 11b is an illustration of a Social Data Model leveraging external Risks and Governance Factors;

FIG. 11c is an external third party ERP and Legacy integration for governing any application;

FIG. 12 is a flow chart illustrating the Governance as a Service Business End User View;

FIG. 13 is a flow chart illustrating the Confident Governance Technical Integration Schema for one embodiment of the present invention;

FIG. 14 is a flow chart illustrating the Governance as a Service for one embodiment of the present invention;

FIG. 15 is a flow chart illustrating the Governance and Risk Rules Filter;

FIG. 16 is a flow chart illustrating the Governance as a Service Stack; and

FIG. 17 is a flow chart illustrating the Confident Governance Collaboration Engine Data Schema for one embodiment of the present invention.

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention. Referring to the figures, it is possible to see the various major elements constituting the apparatus of the present invention.

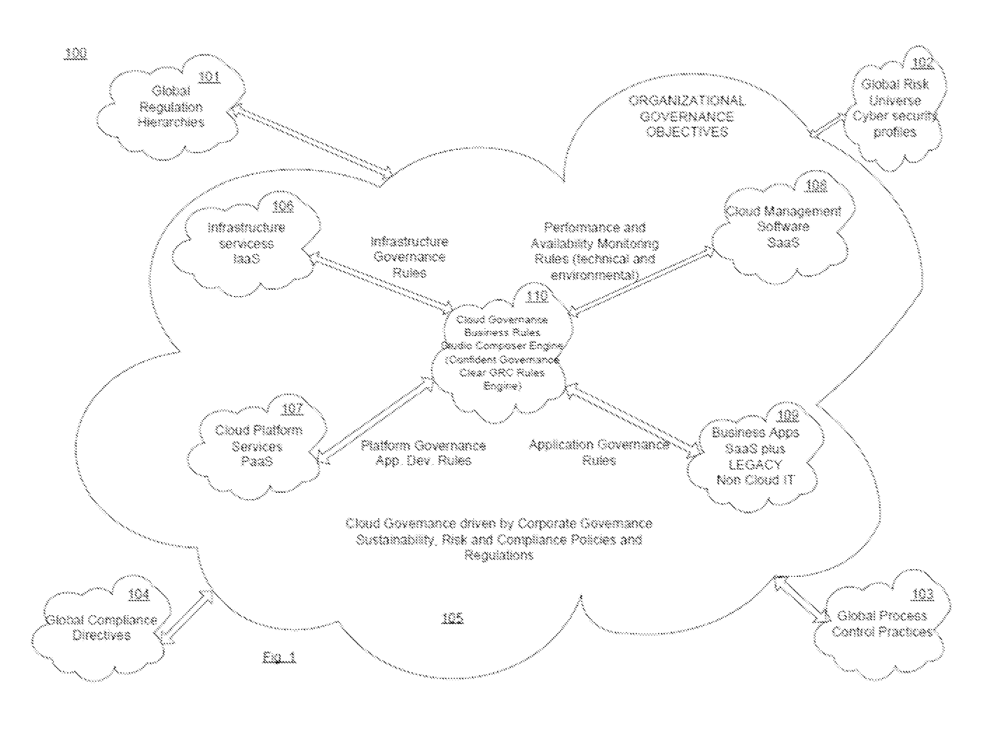

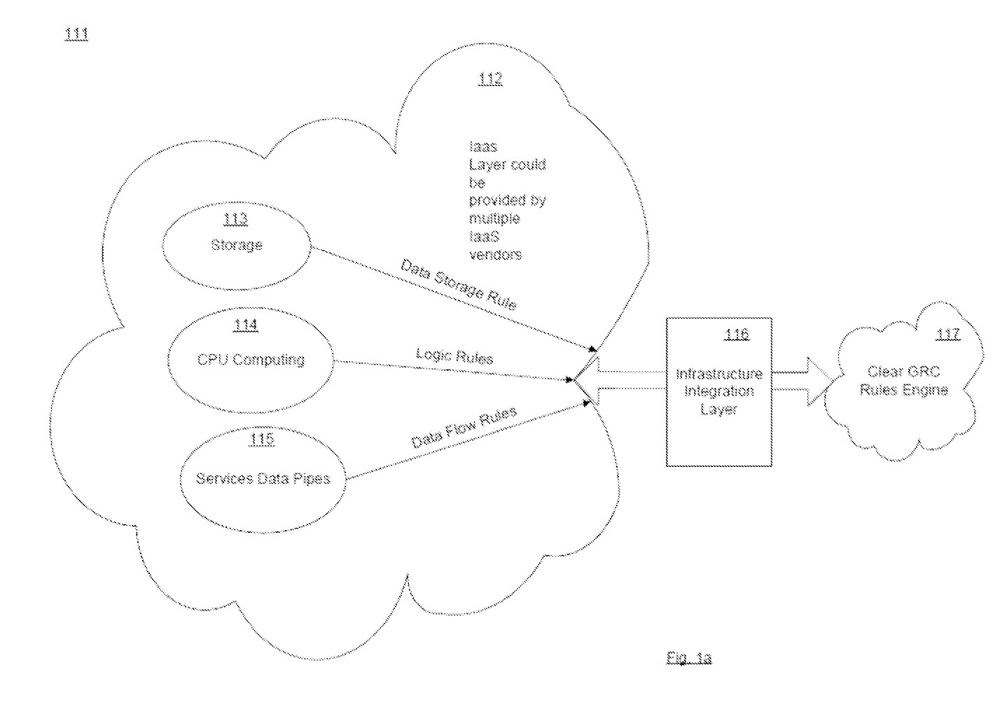

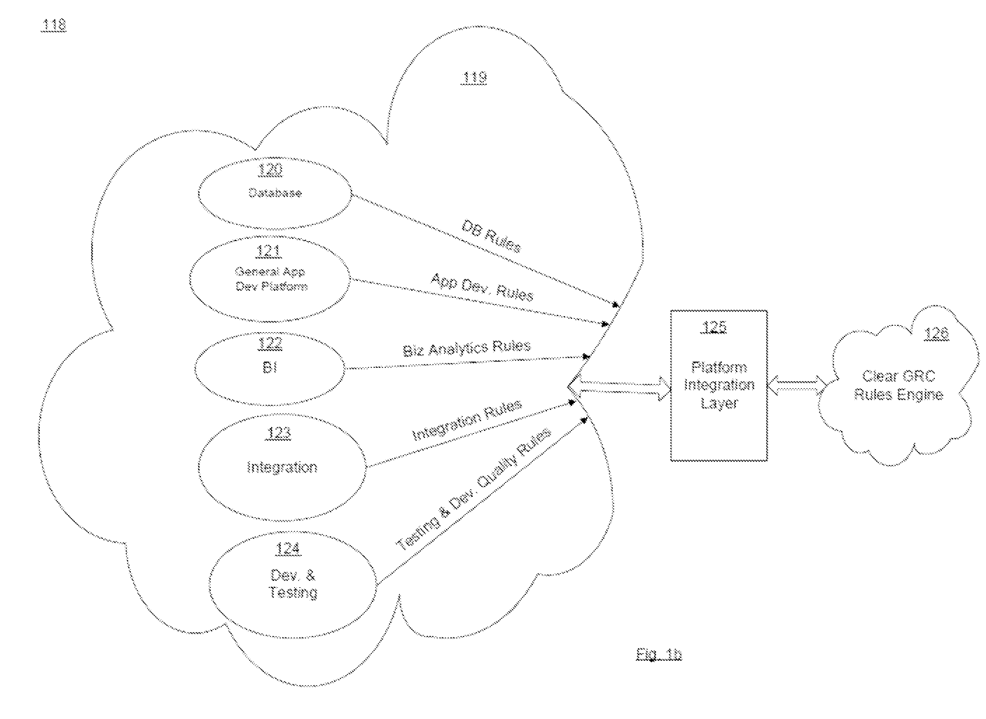

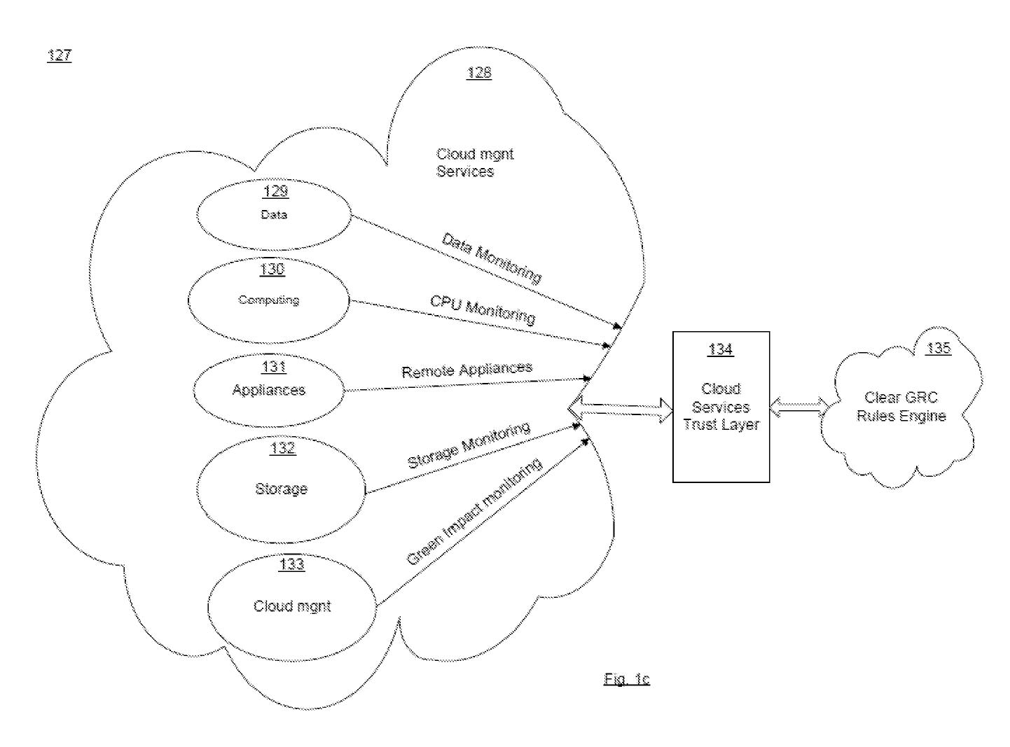

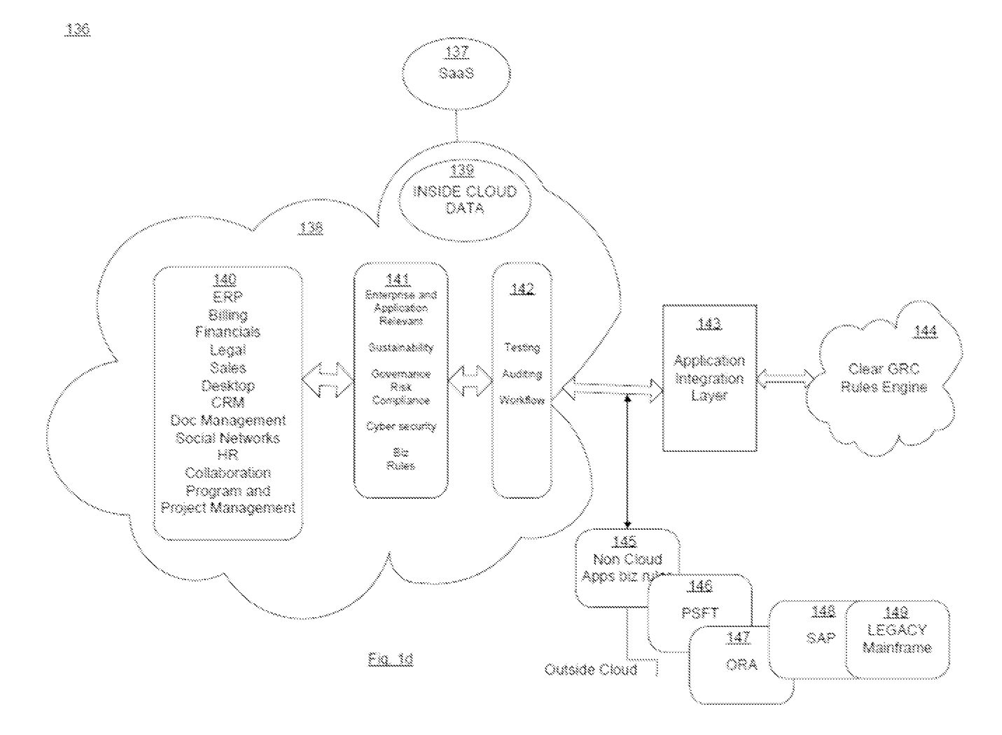

Now referring to the Figures, the embodiment of the cloud based governance, cyber security, risk, and compliance system and method is illustrated. Now referring to FIG. 1, a flow chart illustrating the positioning of the governance cloud 100 is shown. The cloud governance business rules studio composer engine 110, also known as the confident governance clear GRC rules engine, communicates infrastructure and governance rules from the infrastructure services IaaS 106; performance and availability monitoring rules for technical and environmental information from the cloud management software SaaS 108; application governance rules from the business applications SaaS plus Legacy non-cloud IT 109; and platform governance application development rules from the cloud platform services PaaS 107 and in combination comprises the cloud governance driven by corporate governance sustainability, cyber security, risk and compliance policies, and regulations cloud 105. The cloud governance driven by corporate governance sustainability, cyber security, risk and compliance policies, and regulations cloud 105 communicates with the global regulation hierarchies 101, global risk universe and cyber securuity profiles 102, global compliance directives 104, and global process control practices 103.

The Clear GRC cloud governance rules are created from interaction with: the IaaS infrastructure services to obtain the infrastructure governance rules further shown in FIG. 1a; the PaaS cloud platform services further shown in FIG. 1b; the SaaS cloud business application and governance rules further shown in FIG. 1d; and the SaaS cloud management services software containing the logs and monitoring rules further shown in FIG. 1c.

FIG. 1a is a flow chart illustrating the infrastructure governance 111. The IaaS infrastructure governance 112 could be provided by multiple IaaS vendors and is comprised of: storage with data storage rules 113; CPU computing with rules and logic 114; and service data pipes with data flow rules 115 which communicates with the infrastructure integration layer 116 and clear GRC rules engine 117.

FIG. 1b is a flow chart illustrating the platform governance 118. Platform governance is comprised of: a database with database rules 120; a general application development platform with application development rules 121; a Business Intelligence “BI” with business analytics rules 122; an integration component with integration rules 123; and a development and testing component with development and testing rules 124 that all interact in an umbrella cloud 119 with the platform integration layer 125 which communicates with the clear GRC rules engine 126.

FIG. 1c is a flow chart illustrating the cloud management software integration 127. The cloud management software integration services cloud 128 is comprised of: data with monitoring 129; computing with CPU monitoring 130; appliances with remote appliances 131; storage with monitoring 132; and cloud management with monitoring and rules 133 which communicates with a cloud services trust layer 134 layer which communicates with a clear GRC rules engine 135.

FIG. 1d is a flow chart illustrating the cloud business application governance 136. The cloud business application governance cloud 138, implemented by SaaS 137, is comprised of application business logic including but not limited to: ERP (Enterprise Resource Planning), Billing, Financials, Legal, Sales, Desktop, CRM (Customer Relationship Management), Document Management, Social Networking, Human Resources, and Collaboration, program and project management 140 which all interact with the application relevant business rules 141 such as enterprise application relevant, sustainability, governance, risk, compliance, cyber-security, and business rules. Testing, auditing, and workflow 142 communicates with the platform integration layer 143 connected to a clear GRC rules engine 144. Additionally, non-cloud application business rules 145 from an outside cloud 150 can be joined with the cloud business application output as it is sent to the platform integration layer 143. This may include PSFT 146, ORA 147, SAP 148, and LEGACY mainframe 149.

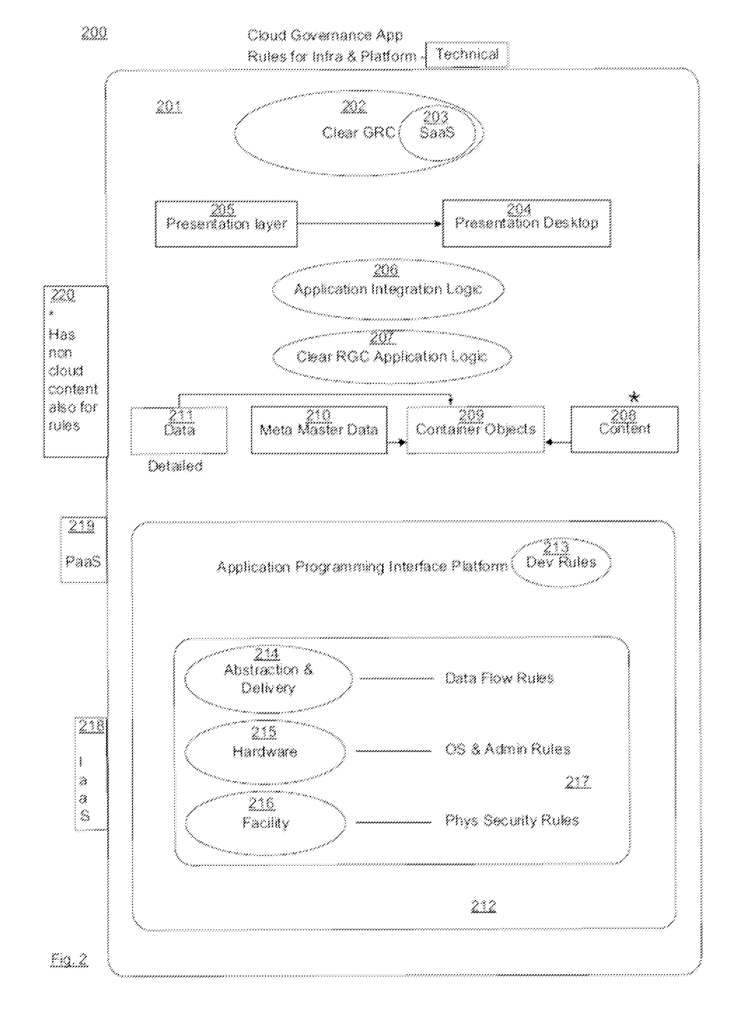

FIG. 2 is a flow chart illustrating the technical components of the cloud governance application and rules for the infrastructure and platform 200. The Clear GRC modules 202 in the cloud 201 are implemented by the SaaS environment 203 and include: a presentation layer 205; presentation desktop 204; application integration logic 206; Clear GRC application logic 207; data 211; meta master data 210; container object 209; and contacts 208. The PaaS level 212 is comprised of an application programming interface platform with device rules 213. The IaaS level 217 is comprised of the abstraction and delivery of data based on established rules 214; hardware including the operating system and administration rules 215; and the facility which includes the physical security rules 216.

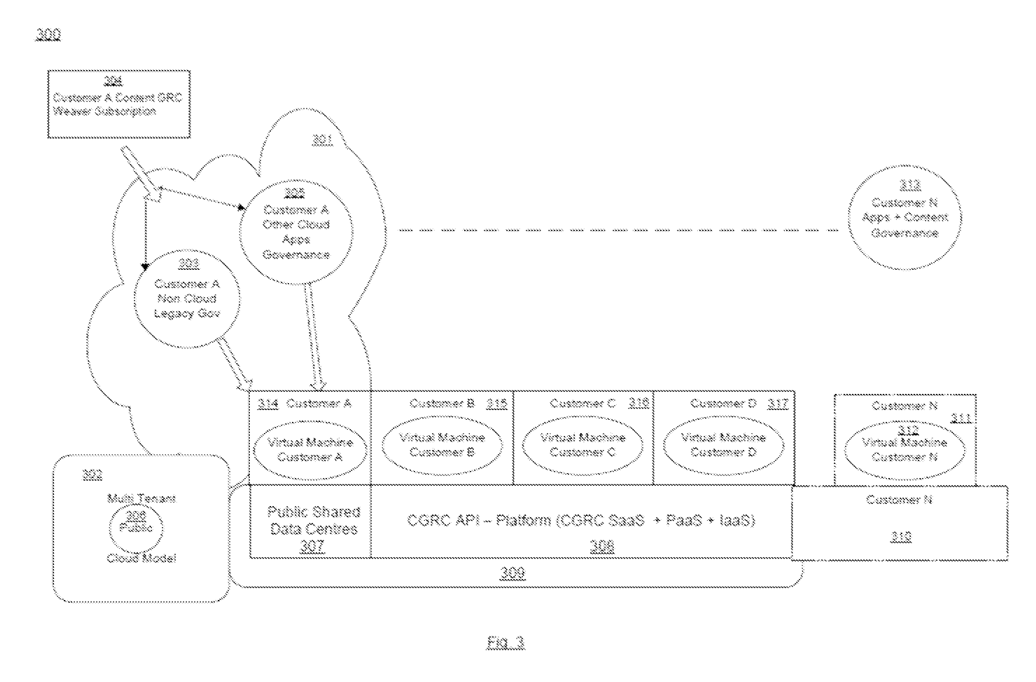

FIGS. 3-3a is a flow chart illustrating the cloud governance use case 300. A first customer, customer A 314, can subscribe to a content subscriptions 304 for corporate governance, cyber security, risk, compliance and resolution, and other business rules subscriptions which will receive regular and periodic business rules updates 301 that are composed of rules impacting a Cloud application 305 or legacy system 303 in a customer's applications and content governance in their own environment 313. Customer A can also add and provide access to a plurality of clients through the power of the multi-tenant cloud platform 302. Similarly in a multi-tenant Public Cloud scenario 306, customers B through N 315, 316, 317, 310, and 311 can subscribe and manage their own applications and governance objectives 313 in privacy and security of their own virtual machines. The underlying data center 307 is shared across all customers and the governance as a service platform API also known as ClearGRC API 308 (consisting of CGRC SaaS built on Paas and IaaS) is also shared. This underlying platform sharing to have a shared cloud governance and shared non cloud governance 309 benefits all customers thereby dramatically reducing cost of resources to govern and manage each divisional entity. This illustrates a pure public cloud scenario use case.

Now referring to FIG. 3a, the SaaS level 320 includes the Cloud governance API, and clear GRC 319, force.com PaaS 321 and Amazon IaaS 322 as an example. Under this layer, company A may have a subscription layer that provides a multiple tenant private cloud 326 that can be divided by company division 325, 329, and 330 which can then access customer A's private onsite 331 data center 327 leveraging the Clear GRC, API and PaaS and IaaS systems 328. The multiple tenant private cloud 326 is enabled to manage either non-cloud governance 324 or could governance 323. This scenario illustrates a private cloud use case.

Additionally, each divisional can have a shared cloud governance 340 and shared non cloud governance 318 that can also interact with customer A through a series of virtual machines 337, 338, and 339 in both a public 332 shared data center 333 and a private 336 onsite data center 335 leveraging Clear GRC, API and PaaS and IaaS systems 334.

A division may include a virtual private machine 337 that communicates with the division's cloud governance 341, non-cloud governance 344, and GRC weaver subscription 342, based on multi-tenant hybrid cloud 343. This scenario illustrates a hybrid private and public cloud use case

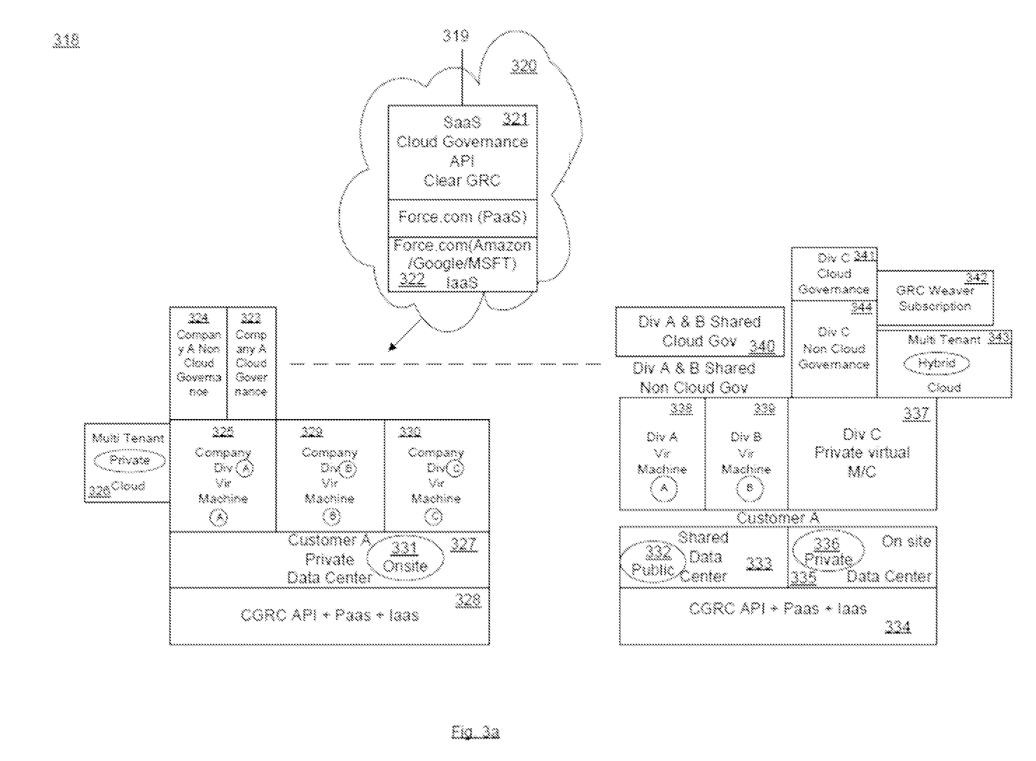

FIG. 4 is a flow chart illustrating the dashboard methodology of the present invention. The cloud governance dashboard analytics engine 400 layout is configurable from a plurality of presentation 405 and layout configuration 406 options. Standard or custom objects 401 are converted to reports 403 by an analytics engine 402 in either a standard or custom format, which are then accessible through drill down menus or displays by the dashboard presentation layer 404 that provides geo-graphic and geo-spatial risk mapping visualization. The dashboard can then send messages 407 to users via desktops 408 or mobile devices 409 or provide a visual display via the visualization engine 410. The visual display may be one of several configurations, including, but not limited to, a pie chart 412, donut chart 413, gauge chart 414, funnel chart 415, and/or other visual formats such as Heat Maps 416. The Visual display also is drag and drop or plug and/or a play selection between various formats of Risk and Governance Visualization pattern logic 411.

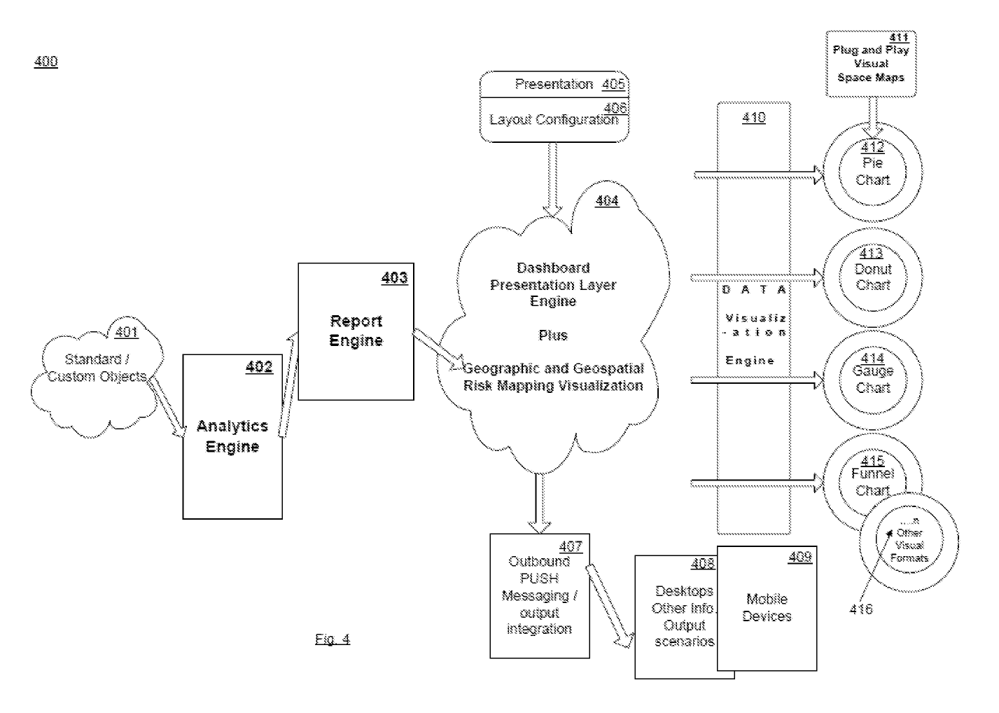

Now referring to FIG. 5, a flow chart illustrating the cloud governance reporting 500 methodology of the present invention is shown. A report type 506 is determined by the custom objects 502 and standard objects 501 contained within the data 504. The selected report type configuration, using query optimization 505, is then sent to the custom report logic 508, which uses input from standard formulas 509, custom formulas 510, and filters 511 for sorting report information to generate a visual display by the data visualization engine 511. The reports are then sent to a dashboard 512 for data visualization to occur before a user for review and the data is exported 513 as desired in many different formats.

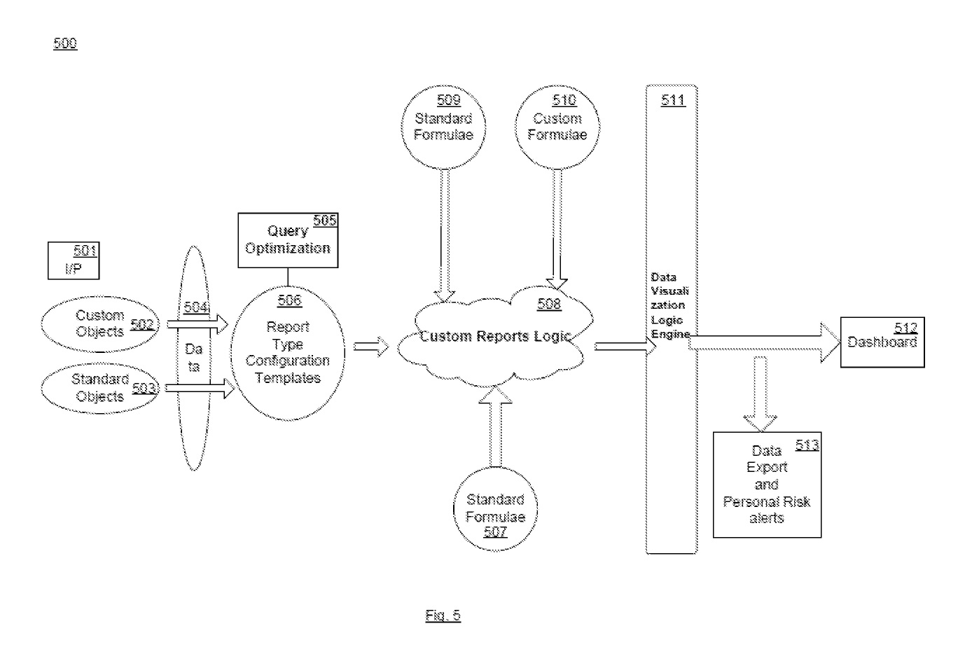

FIG. 6 is a flow chart illustrating the technical perspective governance object 600 of the present invention. Inbound continuous improvement ideas 601 are received by the governance collaboration engine 602 along with information from social media risk monitors 603, cyber-security and global risk monitors 605, and global news monitors 604 which then collaborates 606 with the cloud governance mirror data 607, strategic board level details 608, and governance details data 609 before logic for testing 613. The clear governance technical object 619 then uses mass data input 611 received via a data management element 612, data attachments 610, correlation logic 618 and 624 consisting of the company hierarchy 627 and regulation hierarchy 625 as well as resilient risk 616 and the rules studio 617 to evaluate the data inputs 614, 615, 628, and 626 before filtering the data 629 and generating a report. The governance technical object 637 is comprised of: the view, page, search, and layout configurations 620, SaaS details 621, control risk lookup 623, and operations domain 622. The filtered data is then transformed into a report through the use of formula configuration 630, filters 633, and management manipulation 632 before it is exported by the reports logic 631. The reports are then sent to a dashboard 635 for data visualization to occur before a user for review and additional collaboration 636. Upon visual display and review, collaboration among multiple users can occur as provided by the governance collaboration engine. Based on this 360-degree collaborative Governance format, policies and objectives for governance designed and situated in the Governance technical Object are continuously refreshed and updated.

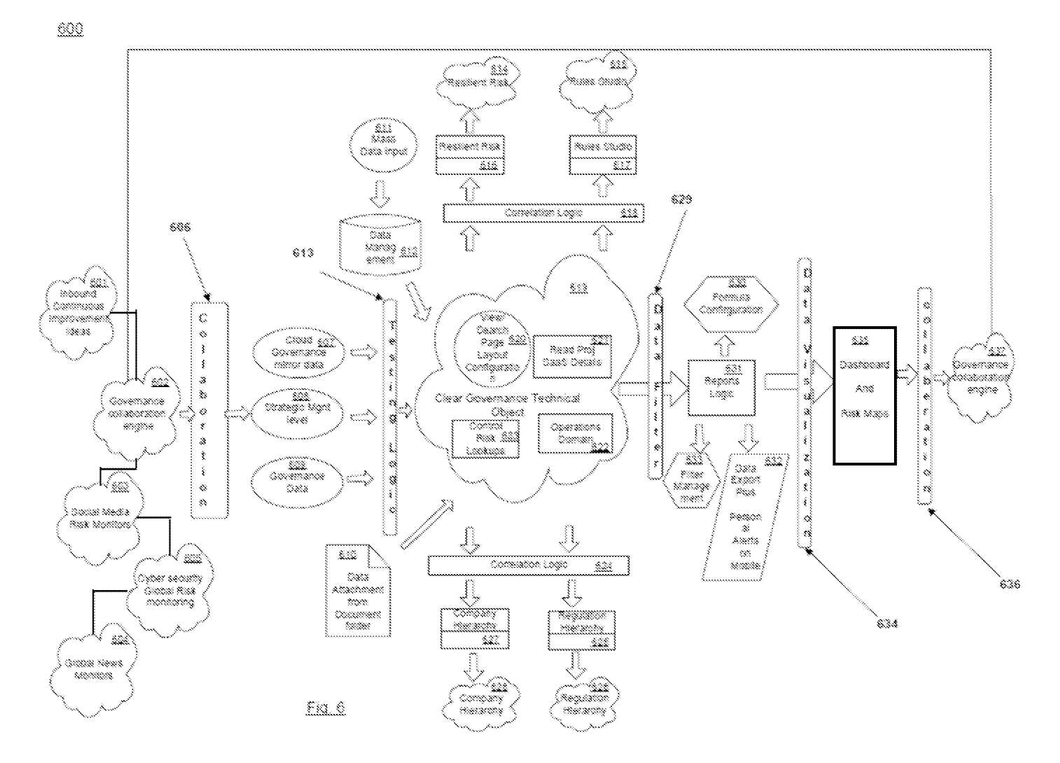

Now referring to FIG. 7 a flow chart illustrating the technical perspective resilient risk object 700 of the present invention is shown. The governance collaboration engine 701 provides the collaboration logic 702 for considering financial exposure 703, assessment 704, and basic risk information 705. Testing of the logic 709 is then performed by the resilient risk technical object 715. The resilient risk technical object 715 is comprised of: view, search, page, layout configurations 717, enterprise risk management properties 716, impact formulization 718, and probability formulization 719. The resilient risk technical object 715 uses mass data input 707 received via a data management element 708, data attachments 706, and workflow management 726 and then applies the correlation logic 712 and 721 consisting of: governance 710 correlated from the governance junction 711, rules 713 correlate from the rules junction 714, company hierarchy 725 correlate from the company hierarchy element 724, and regulation hierarchy 725 to the data correlate from the regulation hierarchy element 723 before creating a report. The filtered data 720 is then transformed into a report by the reports engine 734 through the use of filters and management manipulation 727 and 728 before it is exported 729. The reports are then sent to a dashboard 731 for data visualization 730 to occur before a user for review and additional collaboration 732. Upon visual display and review, collaboration 732 among multiple users can occur as provided by the governance collaboration engine 733. Upon visual display and review, collaboration among multiple users can occur as provided by the governance collaboration engine 733. Based on this 360-degree real time collaborative Risk format, enterprise level risk information is constantly evaluated and risk parameters updated. If new risks are presented outside the Cloud environment they are able to be captured through feeds from online services such as Twitter and Google etc. providing real-time and live Risk perspective globally.

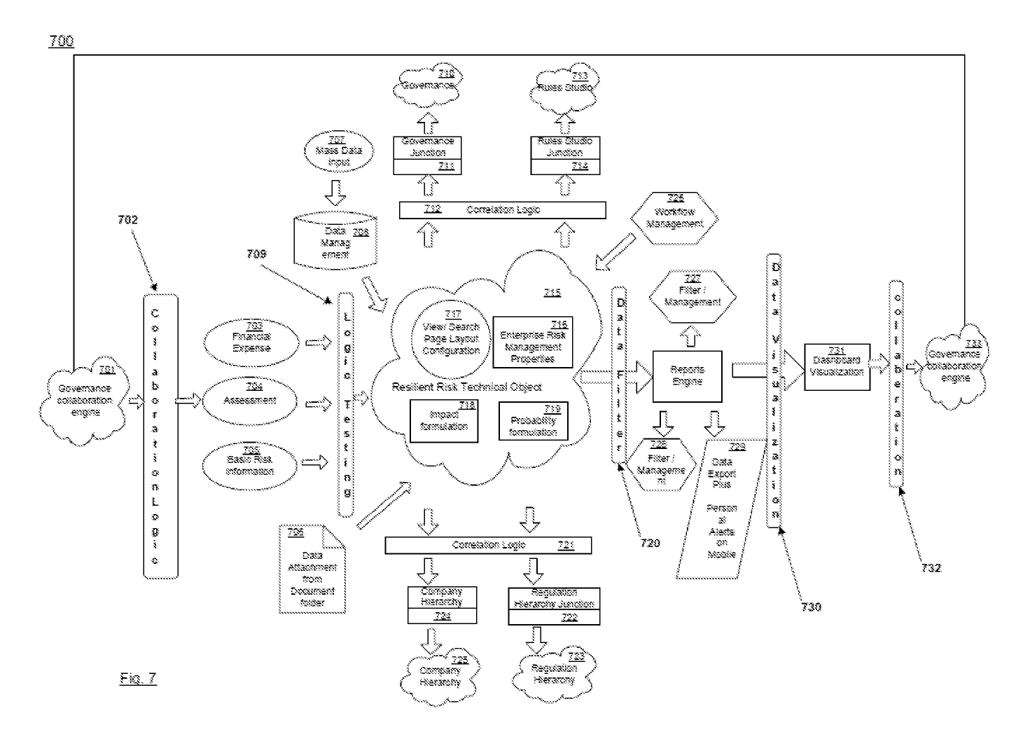

FIG. 8 is a flow chart illustrating the technical perspective rules engine object 800 of the present invention. The governance collaboration engine 801 provides the collaboration logic 802 for the rules characteristic data 803, rules design data 804, and rules operational assessment data 805. Testing of the logic 809 is then performed by the rules studio 820. The rules studio 820 is comprised of: view, search, page, layout configurations 824; rule comment 821; rule evidence testing 823; and rule characteristic classification 822. The rules studio 820 uses mass data input 807 received via a data management element 808, data attachments 806, and workflow management 825 and then applies the correlation logic 819 and 814 consisting of: governance 815 received from the governance junction 818, rules 816 received from the rules junction 817, company hierarchy 811 received from the company hierarchy element 810, and regulation hierarchy 813 to the data received from the regulation hierarchy element 813 before creating a report. The filtered and sorted data is then transformed into a report by the reports engine 827 through the use of filters and management manipulation 826 before it is exported 828. The reports are then sent to a dashboard 830 for data visualization to occur before a user for review. Upon visual display and review, collaboration 831 among multiple users can occur as provided by the governance collaboration engine 832.

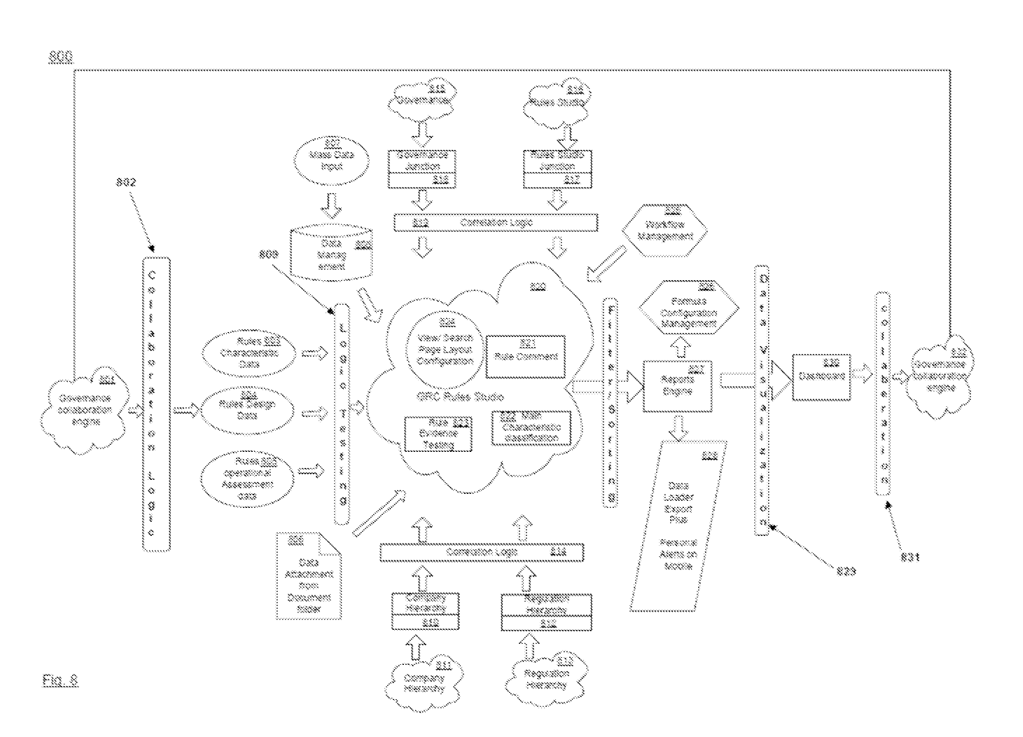

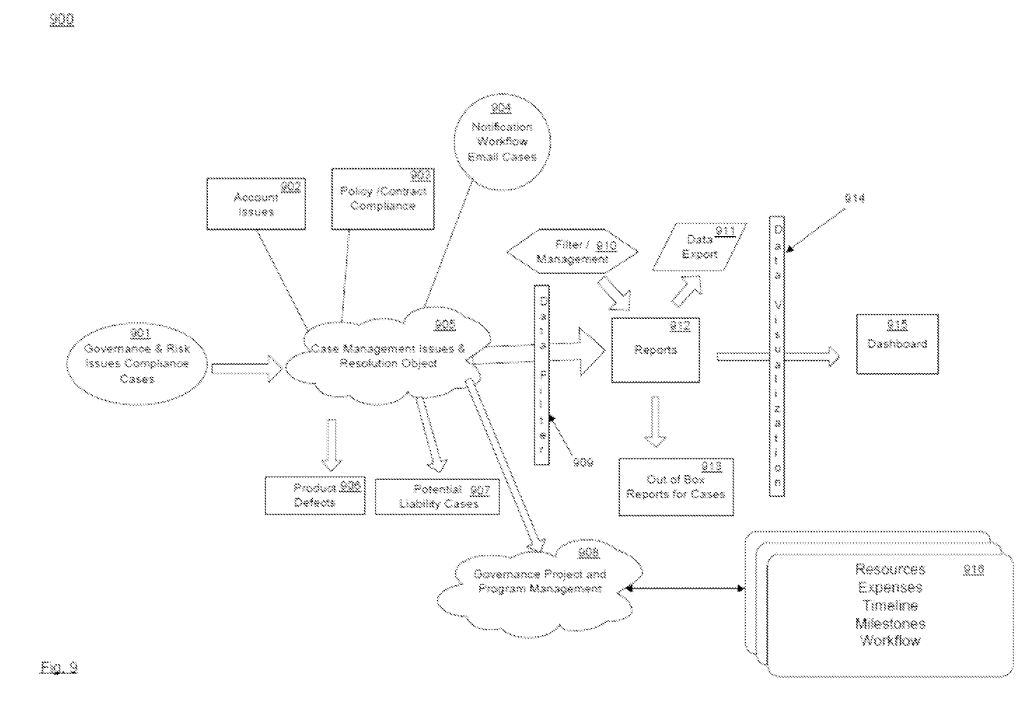

FIG. 9 is a flow chart illustrating the Governance Issues and Case management method 900 of the present invention. The case management issues and resolution object 905 contains governance related issues and maps them to other objects such as Accounts 902, email cases 904, and contracts information 903. The case management issues and resolution object 905 receives governance, mass email cases, and risk issues and compliance cases 901 as input and generates process related issues remediation output or risk and potential liability related action items such as product defects 906, potential liability cases 907, governance project and program management 908, and filtered data as output. The governance project and program management 908 considers resources, expenses, timelines, milestones, and workflow 916. The filtered data 909 is then combined with another filter or management component 910 to generate an out of box or customized report for each issue instance 913 and data export 911. The reports 912 are then sent to a dashboard 915 for data visualization 914 to occur before a user for review.

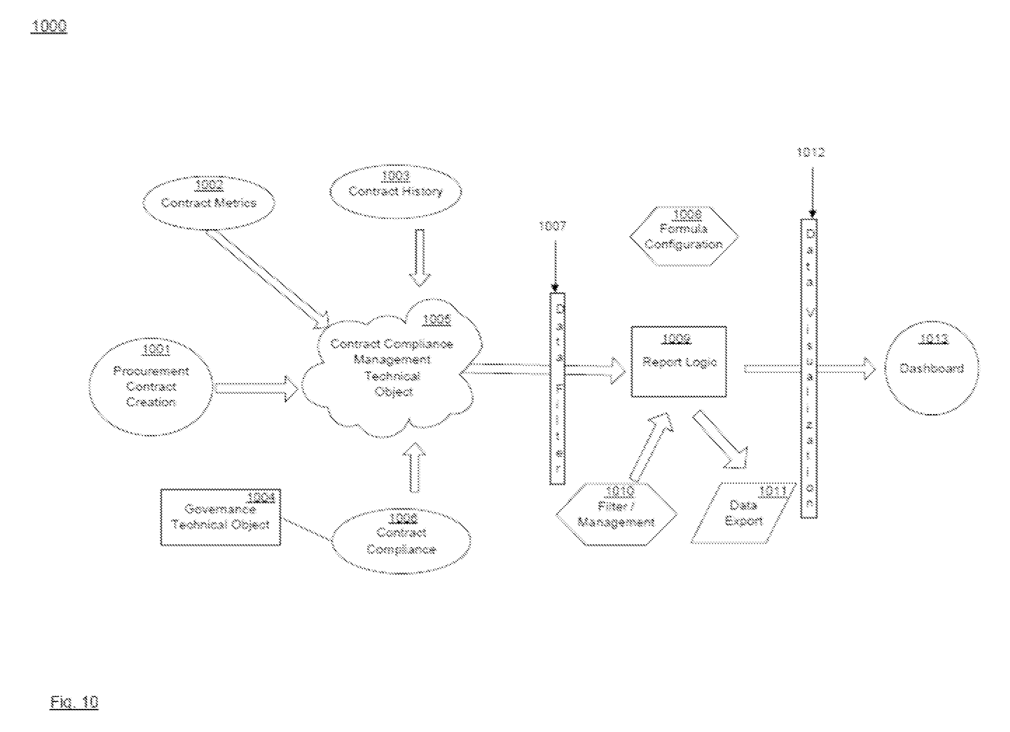

Now referring to FIG. 10, a flow chart illustrating the contract management method 1000 of the present invention is shown. A contract compliance management technical object 1005 receives a request for contract creating 1001. The contract compliance management technical object 1005 then accesses contract history 1003, contract metrics 1002, and contract compliance data 1006, the latter, which is stored in the governance technical object 1004 to generate filtered data output 1007. The filtered data is then transformed into a report and report logic element 1009 through the use of formula configuration 1008 and filters and management manipulation 1010 before it is exported 1011. The reports are then sent to a dashboard 1013 for data visualization 1012 to occur before a user for review.

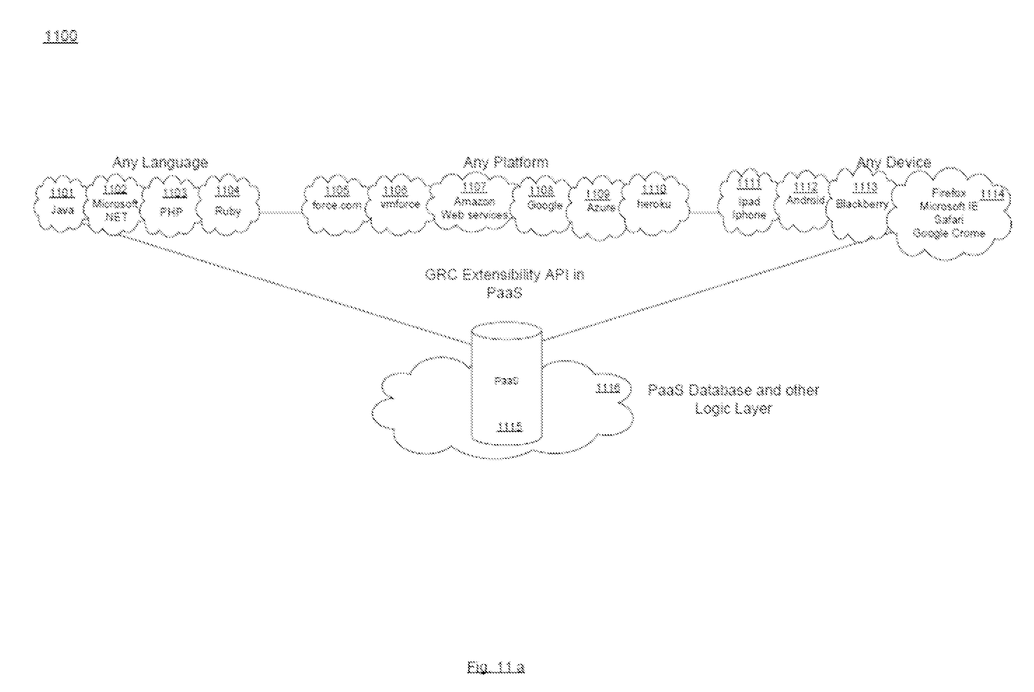

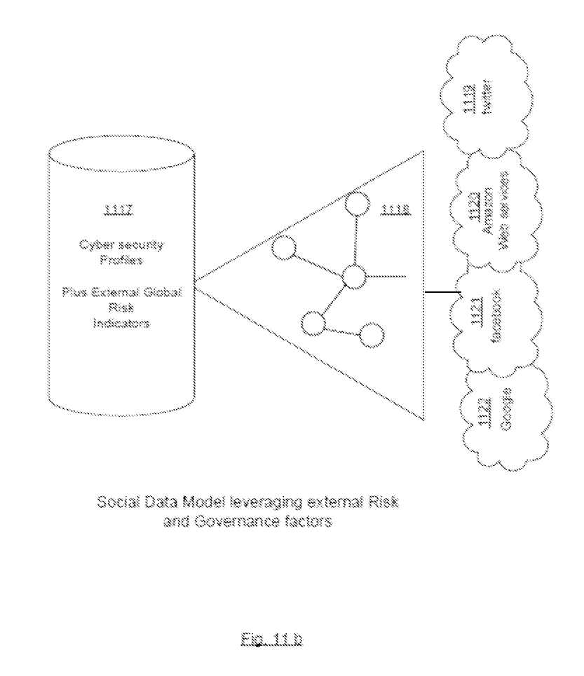

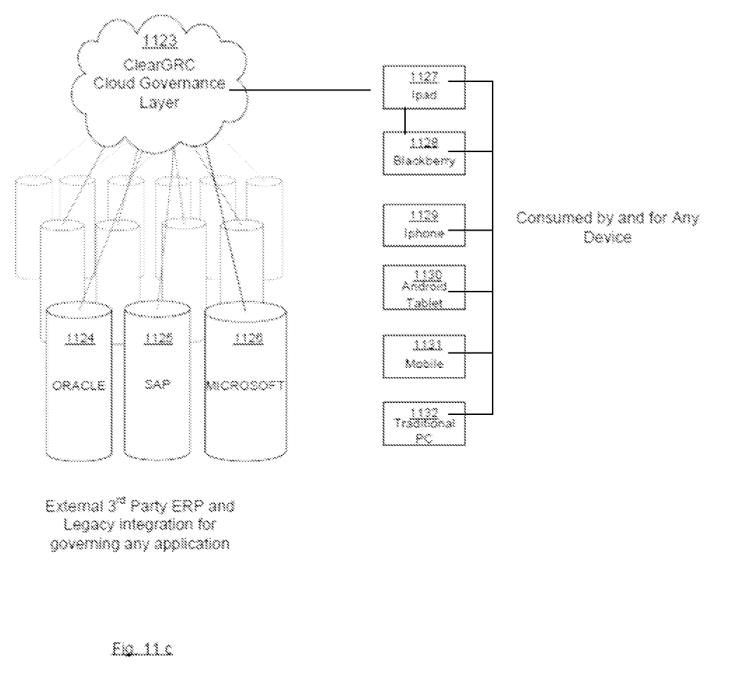

Now referring to FIG. 11a, the GRC API may be written in any language such as JAVA 1101, MICROSOFT.NET 1102, PHP 1103, and RUBY 1104; executed on any platform such as: FORCE.COM 1105, VMFORCE 1106, AMAZON WEB SERVICES 1107, GOOGLE 1108, AZURE 1109, and HEROKU 1110; and enabled or run on any device such as: IPAD/IPHONE 1111, ANDROID 1112, BLACKBERRY 1113, AND FIREFOX/MICROSOFT IE/SAFARI/GOOGLE CHROME 1114 by PaaS 1115 on a PaaS database and/or other logic layers 1116.

FIG. 11b illustrates a social data model leveraging external risk factors and governance factors. A PaaS database 1117 comprised of cyber-security profiles and external global risk intelligence is, through any number and type of connections 1118, linked to a plurality of social networks such as GOOGLE 1122, FACEBOOK 1121, AMAZON WEB SERVICE 1120, and TWITTER 1119.

Now referring to FIG. 11c, an external, third party, ERP and Legacy integration for governing any application is illustrated. A clearGRC cloud governance layer 1123 is connected to a plurality of ORACLE 1124, SAP, and MICROSOFT 1126 platforms. The clear GRC cloud governance layer 1123 provides access by a plurality of consumer devices such as the IPAD 1127, BLACKBERRY 1128, IPHONE 1129, ANDROID 1130, mobile devices 1131, AND VODAFONE 1132 to the plurality of ORACLE 1124, SAP, and MICROSOFT 1126 platforms to which the clearGRC cloud governance layer 1123 is connected and communicates between. Alternatively, The clear GRC cloud governance layer 1123 provides access by tablets, traditional personal computers, and other similar mobile devices to those previously mentioned.

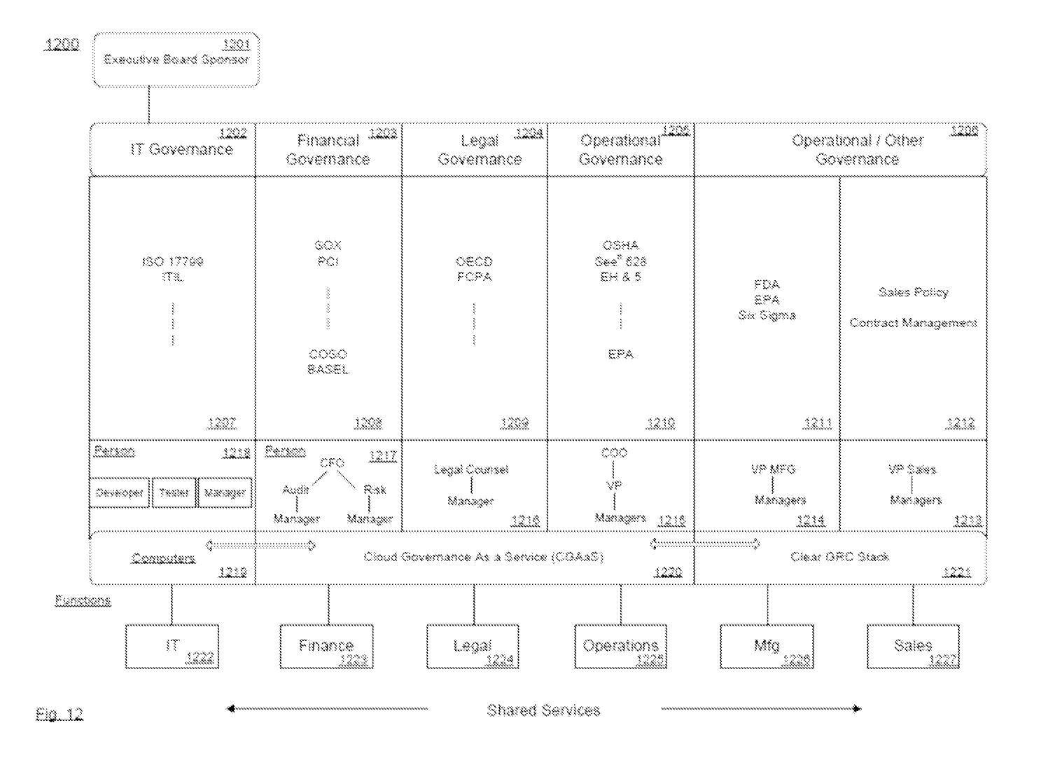

FIG. 12 is a flow chart illustrating the Governance as a Service Business End User Corporate View 1200. The executive board sponsor 1201 has the overall responsibility across all enterprise governance domains and controls the IT governance 1202, financial governance 1203, legal governance 1204, operational governance 1205 and operational and other governances 1206. Each of the governance domains (1202, 1203, 1204, 1205, 1206) in turn contain a specific set of regulatory, performance driven and/or compliance driven mandates (1207, 1208, 1209,1210, 1211, 1212), needed people to support such mandates (1218, 1217, 1216, 1215, 1214, 1213) and related computing and business process Governance Risk and Compliance management functions (1219, 1220, 1221) that are then consumed by the enterprise in its various operational domains (1222, 1223, 1224, 1225, 1226, 1227). The IT governance 1202 includes ISO 17799 and ITIL (and other present and future IT governance mandates) 1207, a developer, tester, and manager 1281 and one or more computers 129 to control and govern the IT functions 1222. The financial governance 1203 includes SOX, PCI, COSO, and BASEL (and other present and future Financial governance mandates) 1208 and a CFO overseeing managing audit and risk 1217 to control the Finance functions 1223. The legal governance includes OECD and FCPA (and other present and future Legal Compliance and Regulatory mandates) 1209 as well as legal counsel and a manager 1216 to control the legal functions 1224. The operational governance includes OSHA and EPA standards (and other present and future Operational governance mandates) 1210 as well as the COO, VP, and other managers 1215 to control the operational functions 1225. The operational and other governance level 1206 is comprised of FDA, EPA, Six Sigma and similar rules, (and other present and future evolving regulatory and compliance mandates) 1211 in additional to sales policy and contract management rules 1212. Also included are the Vice President of Manufacturing and other managers 1214, and VP of sales and related managers 1213 to effectively oversee the manufacturing 1226 and sales 1227 aspects of the enterprise. The Clear GRC Stack 1221 delivered on the cloud as a governance service (CGAaS) 1220 enable the complete and transparent full enterprise visibility and monitoring across the IT 1202, financial governance 1203, legal governance 1204, operational governance 1205/1206.

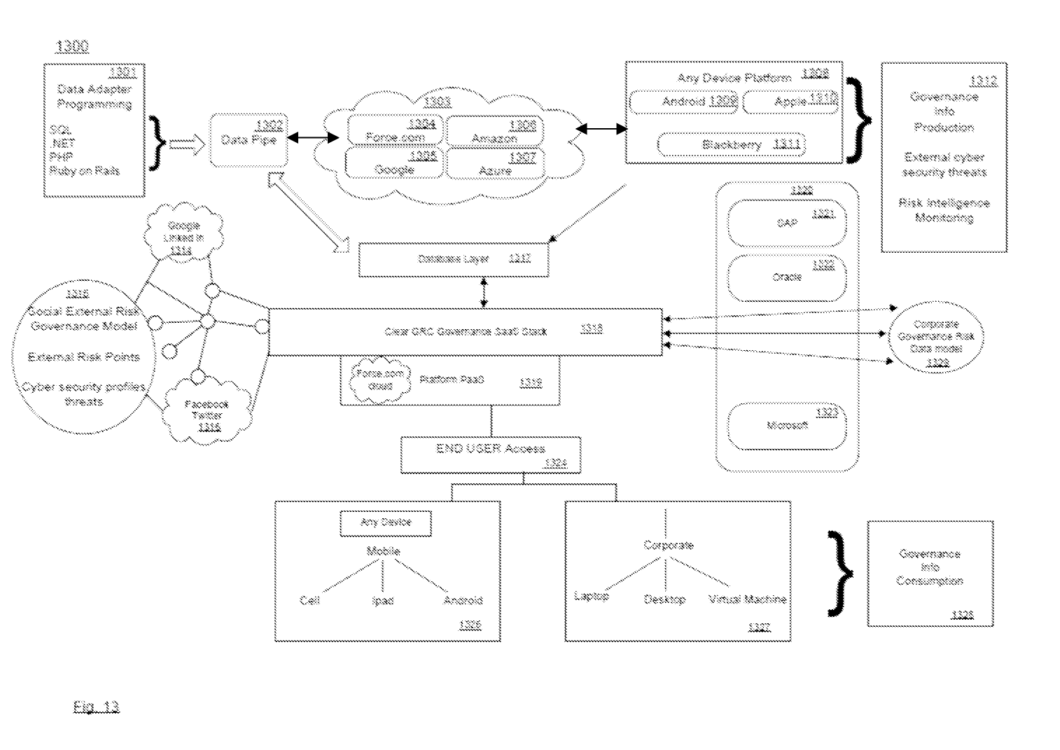

FIG. 13 is a flow chart illustrating the Confident Governance Technical Integration Schema 1300 for one embodiment of the present invention. Data adapter programming 1301 provides information to the data pipe 1302 that transfers it to the database layer 1317. The database layer 1317 interacts with the SaaS level 1303 which includes the force.com PaaS 1304 and Amazon IaaS 1306, GOGGLE 1305, and AZURE 1307 layers as an example. The database layer 1317 also receives information from any device platform 1308 such as the ANDROID 1309, APPLE devices 1310, and BLACKBERRY 1311 that collect governance information production 1312 such as external cyber-security threats and risk intelligence monitoring. The clear GRC Governance SaaS stack 1318 communicates with the database layer 1317 as well as social networks such as GOOGLE/LINKED IN 1314 and FACEBOOK/TWITTER 1316 which communicate with the Social External Risk Governance Model 1315 to obtain external risk points and cyber-security profiles and threats. The clear GRC Governance SaaS stack 1318 communicates via a plurality of platforms 1320 such as SAP 1321, ORACLE 1322, and MICROSOFT 1323 with the Corporate Governance Risk Data model 1329. The Platform PaaS 1319 provides end user access 1319 to the clear GRC Governance SaaS stack 1318. The end user access 1324 can be from any mobile device 1326 or corporate computers 1327 which provide governance information consumption 1328.

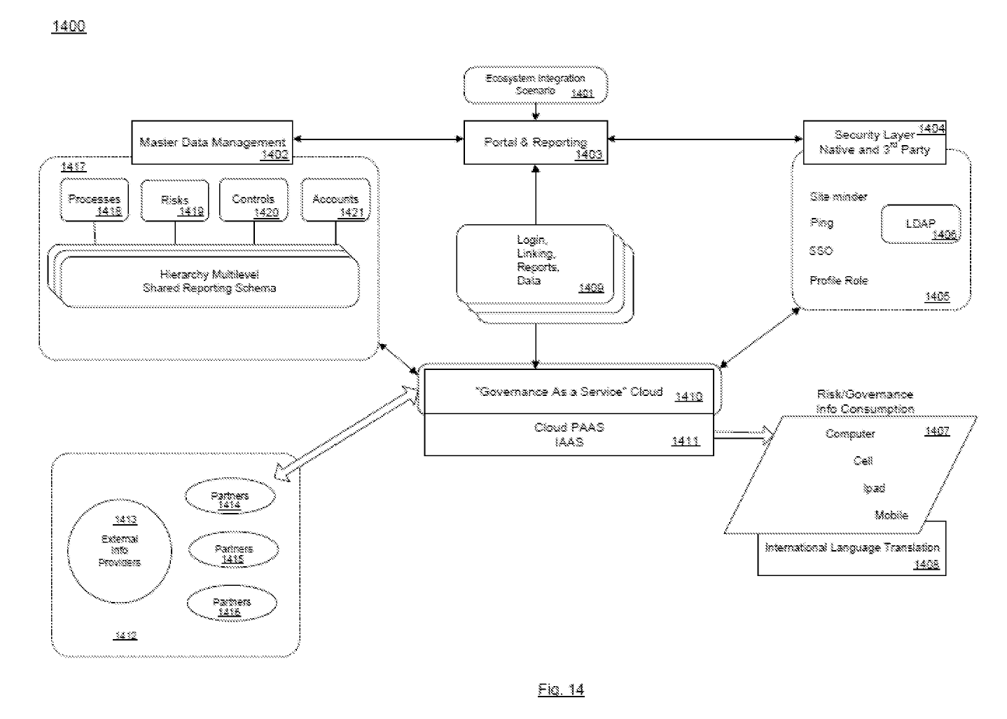

FIG. 14 is a flow chart illustrating the Governance as a Service 1400 for one embodiment of the present invention in an ecosystem integration scenario 1401. The portal and reporting module 1403 communicates with the master data management 1402 and security layer 1404 modules as well as the Governance as a Service Cloud 1410 for receiving login, linking, reports, and data 1409. The master data management 1402 is comprised of a hierarchy multilevel shared reporting schema 1417 consisting of processes 1418, risks 1419, controls 1420, and accounts 1421. The security layer is comprised of site reminder, ping, SSO and profile role 1405 in addition to a LDAP 1406.

The Governance as a Service Cloud 1410 communicates with the master data management module 1402 and the security layer 1404 as well receiving additional information 1412 from one or more partners 1414, 1415, and 1416 and external providers 1413. The cloud PaaS and IaaS layers 1411 communicate with the Governance as a Service Cloud 1410. The cloud PaaS and IaaS layers 1411 send information on risk and governance for consumption by electronic devices 1407 and international translation 1408.

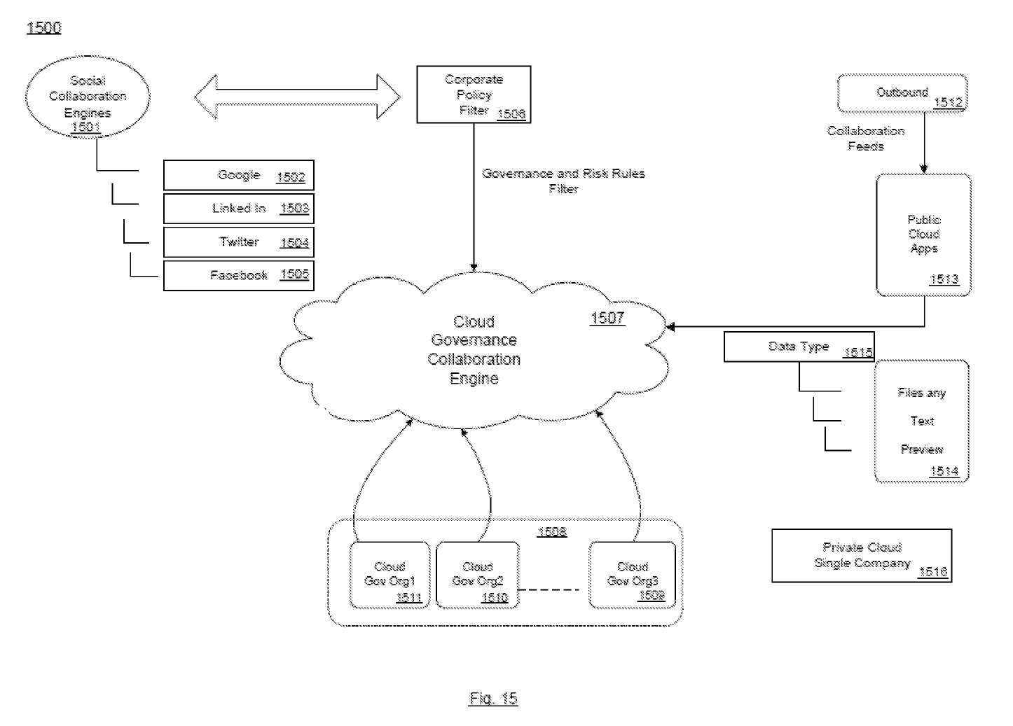

FIG. 15 is a flow chart illustrating the Cloud Governance Rules Collaboration Engine 1500. The social collaboration engines 1501 are comprised of communications with GOGGLE 1502, LINKED IN 1503, TWITTER 1504, and FACEBOOK 1505 and sends information gathered to the corporate policy filter 1506. The cloud governance collaboration engine 1507 takes information received from the corporate policy filter 1506 and public cloud applications 1513 and communicates back and forth with the organization cloud 1508 and the plurality of cloud governance organizations 1509, 1510, and 1511 or a private, single company cloud 1516. The public cloud applications receives outbound collaboration feeds 1512 and transmits them to the cloud governance collaboration engine 1507 in any data type 1515 or as a text preview 1514.

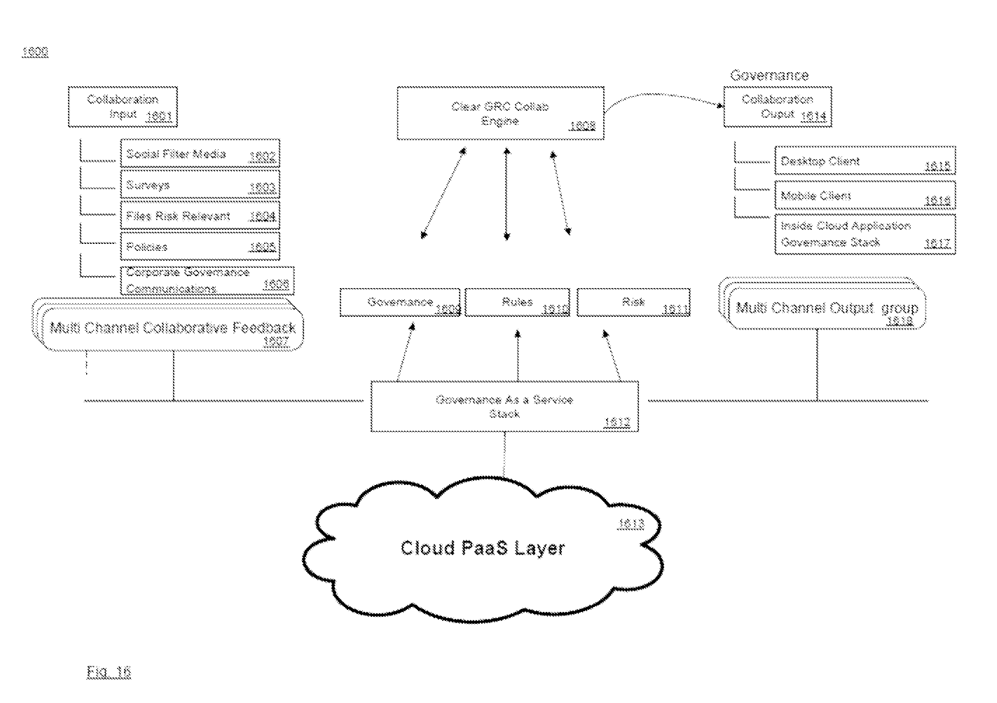

FIG. 16 is a flow chart illustrating the Governance as a Service Stack 1600. The Cloud PaaS layer supports the governance as a service stack 1612. The governance as a service stack 1612 receives input and communicates with a multi-channel output group 1618 and a multi-channel collaborative feedback group 1607 that is comprised of collaboration input 1601 such as social filter media 1602, surveys 1603, files of risk relevancy 1604, policies 1605, and corporate governance communications 1606. The governance as a service stack 1612 sends this information to the governance 1609, rules 1610, and risk 1611 modules, which combine the information with additional information received from and sent to the clear GRC collaboration engine 1608.

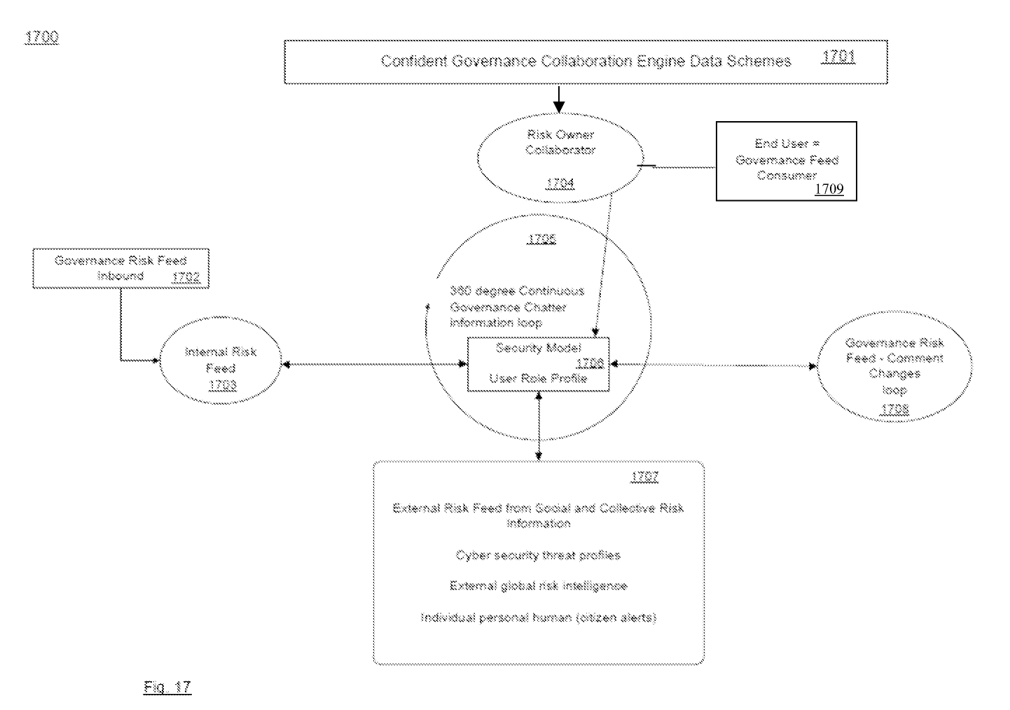

Finally, FIG. 17 is a flow chart illustrating the Confident Governance Collaboration Engine Data Schema 1700 for one embodiment of the present invention. A 360 degree continuous governance chatter information loop 1705 is created by the receipt of the security model and user role profile 1706 of information from a risk owner collaborator 1704 supported by an end user 1701, governance risk feed 1708 providing a comment changes loop, external risk feed from external global risk intelligence and social and collective risk information 1707 and an internal risk feed 1703 supported by inbound cyber-security threats and a governance risk feed 1702.

Although the present invention has been described in considerable detail with reference to certain preferred versions thereof, other versions are possible. Therefore, the point and scope of the appended claims should not be limited to the description of the preferred versions contained herein.

As to a further discussion of the manner of usage and operation of the present invention, the same should be apparent from the above description. Accordingly, no further discussion relating to the manner of usage and operation will be provided.

The above illustrations provides many different embodiments or embodiments for implementing different features of the invention. Specific embodiments of components and processes are described to help clarify the invention. These are, of course, merely embodiments and are not intended to limit the invention from that described in the claims.

Although the invention is illustrated and described herein as embodied in one or more specific examples, it is nevertheless not intended to be limited to the details shown, since various modifications and structural changes may be made therein without departing from the spirit of the invention and within the scope and range of equivalents of the claims. Accordingly, it is appropriate that the appended claims be construed broadly and in a manner consistent with the scope of the invention, as set forth in the following claims.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

The embodiments of the invention in which an exclusive property or privilege is claimed are defined as follows:

1. A computer-implemented method comprising:
a cloud computer system comprising a SaaS level, a PaaS level, and an IaaS level;
the SaaS level further comprised of:
a presentation layer;
a presentation desktop;
an application integration logic; and
application logic; meta data; master data; container objects; contacts; workflow and collaboration logic; visualization logic; and application and security logic;
the PaaS level further comprised of:
an application programming interface platform with governance business rules and application security logic, collaboration rules and workflow rules as well as business process specific non-technical rules; and
the IaaS level further comprised of:
abstraction and delivery of data based on established rules;
hardware including the operating system and administration rules; and
a facility that includes the physical security rules, cyber security and logical database security rules as well as infrastructure specific technical governance;
execution of tasks and controls for risks; execution of collaboration and workflow engines to assign and track the progress of risk remediation; relation of cyber security, compliance and regulatory risks to multiple business rules enabling on-going management of efficiency and risk mitigation;
maintenance and modification of an industry specific repository of business rules and corporate governance control objectives;
collaborative management of the assessment of specific business process control effectiveness at design level as well as operational level aligning it with overall corporate strategic objectives;
display of customizable reporting dashboards with capabilities to report key corporate governance, cyber security and board objectives aligned with right and threats coming in way of these objectives;
providing executive transparence over compliance and risk mitigation of enterprise risks and hurdles across all levels;
provide visibility in day-to-day field operations for all levels of management;
track and monitor global performance, governance, cyber security, risk and compliance initiatives.

2. The method of claim 1 further comprising the steps of:
communicating platform, infrastructure and governance rules from the platform services PaaS a cloud governance business rules studio composer engine;
monitoring performance and availability rules for technical and environmental information from the cloud infrastructure management layer IaaS;
monitoring application governance rules from the business applications SaaS plus Legacy non-cloud IT a cloud governance SaaS;
providing platform governance application development rules from the cloud platform services PaaS and in combination comprising the cloud governance driven by corporate governance sustainability, cyber security, risk and compliance policies, and regulations cloud;
driving cloud governance transparency by corporate governance sustainability, cyber security, risk and compliance policies, and regulations cloud; and
communicating by corporate governance sustainability, cyber security, risk and compliance policies, and regulations cloud with global regulation hierarchies, global risk universe, global compliance directives, and global process control practices.

3. The method of claim 1 further comprising the steps of:
creating cloud governance rules from interaction with:
the IaaS infrastructure services to obtain the infrastructure governance rules including logs and network information;
the PaaS cloud platform logical and application programming services;
the SaaS cloud business application and governance rules; and
the SaaS cloud management services software containing business driven and strategically aligned monitoring rules.

4. The method of claim 1 wherein the IaaS infrastructure governance is comprised of:
storage with data storage rules;
CPU computing with rules and logic; and
service data pipes with data flow rules that communicate with an infrastructure integration cloud layer and clear GRC rules engine.

5. The method of claim 1 wherein platform governance is comprised of:
a database with database rules;
a general application development platform with application development rules;
a Business Intelligence with business analytics rules;
a geo-spatial and geographic risk and cyber security threat intelligence mapping visualization rules;
an integration component with integration rules; and
a development and testing component with development and testing rules
that all interact in an umbrella cloud with the platform integration layer which communicates with the clear GRC rules engine.

6. The method of claim 1 further comprising a cloud management software integration services cloud layer that is comprised of:
data with monitoring; computing with CPU monitoring;
appliances with remote appliances;
storage with monitoring; and
cloud management with monitoring and rules which communicates with a cloud services trust layer which communicates with a clear GRC rules engine 135.

7. The method of claim 1 wherein the cloud business application governance cloud, implemented by SaaS, is comprised of business applications (listed but not limited to):
ERP, Billing, Financials, Legal, Sales, Desktop, CRM, Document Management, Social Networking, Human Resources, Program and Project governance, IT Governance and Collaboration which all interact with the application relevant business rules and testing, auditing, and workflow which communicates with the platform integration layer connected to a clear GRC rules engine; and
non-cloud application business rules from an outside cloud can be joined with the cloud business application output as it is sent to the platform integration layer.

8. The method of claim 1 further comprising the steps of:
accessing the clear GRC rules engine and customer applications and content governance via either a Cloud application or legacy system;
providing access to a plurality of clients;
providing shared cloud governance and shared non-cloud governance that can also interact with a customer in both a public shared data center and a private onsite data center using the Clear GRC, API and PaaS and IaaS systems;
providing a multi tenant cloud with public access;
providing public data centers by the Clear GRC API IaaS layer.

9. The method of claim 1 wherein,
the SaaS level includes a Cloud governance API, and clear GRC, PaaS, and IaaS 322;
a subscription layer that provides a multiple tenant private cloud that can be divided by company division which can then access a customers private onsite data center using the Clear GRC, API and PaaS and IaaS systems; and
supplementing the multiple tenant private cloud by either non cloud governance or cloud governance; and
sharing cloud and non-cloud governance by each division that can also interact with a customer through a series of virtual machines in both a public shared data center and a private onsite data center using a Clear GRC, API and PaaS and IaaS systems.

10. The method of claim 9 wherein a division may include a virtual private machine that communicates with the divisions cloud governance, non-cloud governance, GRC weaver corporate governance, cyber security, risk, compliance and regulatory business rules subscription, and multi-tenant hybrid cloud.

11. The method of claim 1 wherein,
a cloud governance dashboard analytics engine layout is configurable from a plurality of presentation and layout configuration options;
standard custom objects are converted to reports by an analytics engine in either a standard or custom format, which are then accessible through drill down menus or displays by the dashboard presentation layer; and mapped through geographic and geo-spatial risk mapping layer;
a dashboard can then send messages to users via desktops or mobile devices or provide a visual display via the visualization engine;
the Visual display also is drag and drop or plug and play selection between various formats of Risk and Governance Visualization pattern logic.

12. The method of claim 1 wherein,
a report type is determined by the custom objects and standard objects contained within the data;
the selected report type configuration, using query optimization, is then sent to the custom report logic, which uses input from standard formulas, custom formulas, and filters for sorting report information to generate a visual display by the data visualization engine; and
the reports are then sent to a dashboard for data visualization to occur before a user for review and the data is exported as desired in many different formats.

13. The method of claim 1 further comprising the steps of:
receiving by the governance collaboration engine inbound continuous improvement ideas along with real time 24/7 scheduled information from social media risk monitors, global risk monitors, and global new monitors;
collaborating with the cloud governance mirror data, strategic board level details, and governance details data before
conducting logic testing;
evaluating by the clear governance technical object 619, using mass data input received via a data management element, data attachments, correlation logic and consisting of the company hierarchy and regulation hierarchy as well as resilient risk the data inputs;
filtering the data;
generating a report through the use of formula configuration, filters, and management manipulation;
sending the report to a dashboard for data visualization to occur before a user for review; and
collaboration among multiple users as provided by the governance collaboration engine.

14. The method of claim 1 further comprising the steps of:
providing, by the governance collaboration engine, the collaboration logic for considering financial exposure, assessment, and basic risk information;
testing of the logic by the resilient risk technical object;
using mass data input received via a data management element, data attachments, and workflow management by the resilient risk technical object;
applying the correlation logic consisting of governance received from the governance junction, rules received from the rules junction, company hierarchy received from the company hierarchy element, and regulation hierarchy to the data received from the regulation hierarchy element;
creating a report by the reports engine through the use of filters and management manipulation before it is exported;
sending the reports to a dashboard for data visualization; and
providing visual display and review, and collaboration among multiple users as provided by the governance collaboration engine.

15. The method of claim 1 further comprising the steps of:
providing by the governance collaboration engine, collaboration logic for the rules characteristic data, rules design data, and rules operational assessment data;
testing of the logic is then performed by the rules studio;
using, by the rules studio, mass data input received via a data management element, data attachments, and workflow management;
applying correlation logic consisting of: governance received from the governance junction, rules received from the rules junction, company hierarchy received from the company hierarchy element, and regulation hierarchy to the data received from the regulation hierarchy element;
creating a report by the reports engine through the use of filters and management manipulation;
sending the reports to a dashboard for data visualization to occur before a user for review; and
collaboration among multiple users can occur as provided by the governance collaboration engine.

16. The method of claim 1 further comprising the steps of:
receiving by the case management cloud object program, project, product and process issues and resolution object governance, mass email cases, and risk issues and compliance cases as input;
generating program, project, product and process related issues remediation output or risk and potential liability related action items such as product defects, potential liability cases, and governance project and program management;
filtering the data as output;
combining the filtered data with another filter or management component;
generating an out of box or customized report for each issue instance and data export; and
sending the reports to a dashboard for data visualization to occur before a user for review.

17. The method of claim 1 further comprising the steps of:
receiving by a contract compliance management technical object a request for contract creating;
accessing by the contract compliance management technical object contract history, contract metrics, and contract compliance data;
generating data output;
filtering data;
transforming data into a report by a report logic element through the use of formula configuration and filters and management manipulation; and
sending the reports a dashboard for data visualization to occur before a user for review.
